(19) United States
(12) Patent Application Publication
(10) Pub. No.: US 2025/0174905 A1
(43) Pub. Date: May 29, 2025

(54) BEAMFORMED BISTATIC BACKSCATTERING

(71) Applicant: QUALCOMM Incorporated, San Diego, CA (US)

(72) Inventors: Navid ABEDINI, Basking Ridge, NJ (US); Keerthi Priya DASALA, Bridgewater Township, NJ (US)

(21) Appl. No.: 18/523,297

(22) Filed: Nov. 29, 2023

(51) Int. Cl. H01Q 15/04; H01Q 21/28

(52) U.S. Cl. CPC H01Q 15/04; H01Q 21/28

(57) ABSTRACT

Certain aspects are directed towards an apparatus for wireless communications. The apparatus generally includes: a first antenna array; a first lens; an interconnection circuit coupled between the first antenna array and the first lens; a second lens; and a second antenna array, the second lens being coupled between the interconnection circuit and the second antenna array.

### BACKGROUND

### Field of the Disclosure

Aspects of the present disclosure relate to wireless communications, and more particularly, to techniques for backscatter communication.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides an apparatus for wireless communications. The apparatus generally includes: a first antenna array; a first lens; an interconnection circuit coupled between the first antenna array and the first lens; a second lens; and a second antenna array, the second lens being coupled between the interconnection circuit and the second antenna array.

One aspect provides a method for wireless communications. The method generally includes: receiving a first signal via a first antenna array coupled to a first lens; selectively coupling, via an interconnection circuit, the first lens to a second lens; and transmitting a second signal via a second antenna array coupled to the second lens.

Other aspects provide: an apparatus operable, configured, or otherwise adapted to perform any one or more of the aforementioned methods and/or those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts a radio frequency identification (RFID) system.

FIG. 6 depicts an example system that utilizes a network entity to communicate with ambient internet of things (IoT) devices.

FIG. 7 illustrates a bistatic backscattering system, in accordance with certain aspects of the present disclosure.

FIG. 8 illustrates a bistatic backscattering architecture using Rotman lenses, in accordance with certain aspects of the present disclosure.

FIG. 9 illustrates example techniques for modulating a backscatter signal, in accordance with certain aspects of the present disclosure.

FIG. 10 illustrates an example of signaling to or from a backscattering device.

FIG. 11 illustrates bistatic-backscattering architecture with four antenna arrays, in accordance with certain aspects of the present disclosure.

FIG. 12 depicts a method for wireless communications, in accordance with certain aspects of the present disclosure.

FIG. 13 depicts aspects of an example communications device.

### DETAILED DESCRIPTION

A new generation of wireless devices may overcome conventional limitations of on-board energy storage by harvesting energy from wireless signals (e.g., radio frequency (RF) signals) to perform wireless communications. Such energy harvesting devices (e.g., user equipments) may include, for example, RFID devices (e.g., RFID tags), that are capable of receiving signals and “backscattering” them to another device to perform wireless communications. RFID devices are generally categorized into three type of devices: passive, semi-passive, and active. Passive RFID devices typically have no energy storage and communicate via backscattering. Semi-passive RFID devices have limited energy storage and communicate via backscattering. Active RFID devices have energy storage and are capable of active transmission (generating RF signals).

These aforementioned passive and semi-passive RFID devices may rely partially or entirely on harvested energy from received signals to perform wireless communications (e.g., via backscattering signals). Thus, energy-harvesting (EH) devices (e.g., passive internet of things (IoT)/ambient IoT devices) may be considered a type of user equipment (UE) that provides low-cost and low-power solutions for many applications in a wireless communications system.

In some use cases, EH is used for tasks like data decoding, data reception, data encoding, and data transmission. In such cases, the EH device can have limited energy storage unit to store the harvested energy, and the stored energy may be used to perform data decoding, encoding, filtering, processing, and the like. In other cases, the purpose is not to charge a phone battery in full but to charge the battery of a device (such as a wearable, smart watch, or UE with very low power or use a dedicated battery for EH) in a way that enables some tasks to be performed using the harvested energy. Various tasks such as data decoding, operating some filters, data encoding, transmitting, or receiving data may be done through accumulation of energy harvested over time. In some cases, the EH mode of operation can occur when a battery of a UE (e.g., a phone) is at critically low levels and energy harvesting modes can be used. In some cases, the EH module can work at very low power modes by the UE or when the UE decides to use such low power saving mode. This can be based on a request for the EH mode of operation requested from UE to NW.

In some cases, EH may refer to a plurality of EH techniques/schemes that would be implemented by an EH device. Examples of these EH techniques/schemes may include radio-frequency (RF) EH, light/laser EH, and solar EH. In some cases, EH in this disclosure refers to any wireless EH technique(s) that can be provided from one device (e.g., gNB) to an EH device (e.g., UE), such as RF and laser (using a laser beam). Nevertheless, the ideas can be applicable to other forms of wireless charging/transfer that could be supported from one device to another.

Aspects of the present disclosure provide an architecture and techniques for backscatter communication. Some aspects provide an architecture implemented via lenses (e.g., Rotman lenses) that couple respective antenna arrays to an interconnection circuit. The interconnection circuit may include switches for selectively coupling beam ports of the lenses, allowing energy (e.g., for EH) to be received via at least one antenna array/lens for transmission via at least one other antenna array/lens. In some cases, the interconnection circuit may include various circuits for processing received signals and processing signals for transmission. For example, the interconnection circuit may a modulator for modulating a signal received via a first antenna array for transmission via a second antenna array. Certain aspects also provide various signaling to facilitate backscatter-type communication. For example, a backscatter device may transit information indicating a capability of the device with respect to backscatter-type communication. The backscatter device may also receive an indication of a configuration associated with the backscatter-type communication, as described in more detail herein. In some aspects, the lenses may be used to implement analog beamforming, allowing for increased gains for backscatter-type communication.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

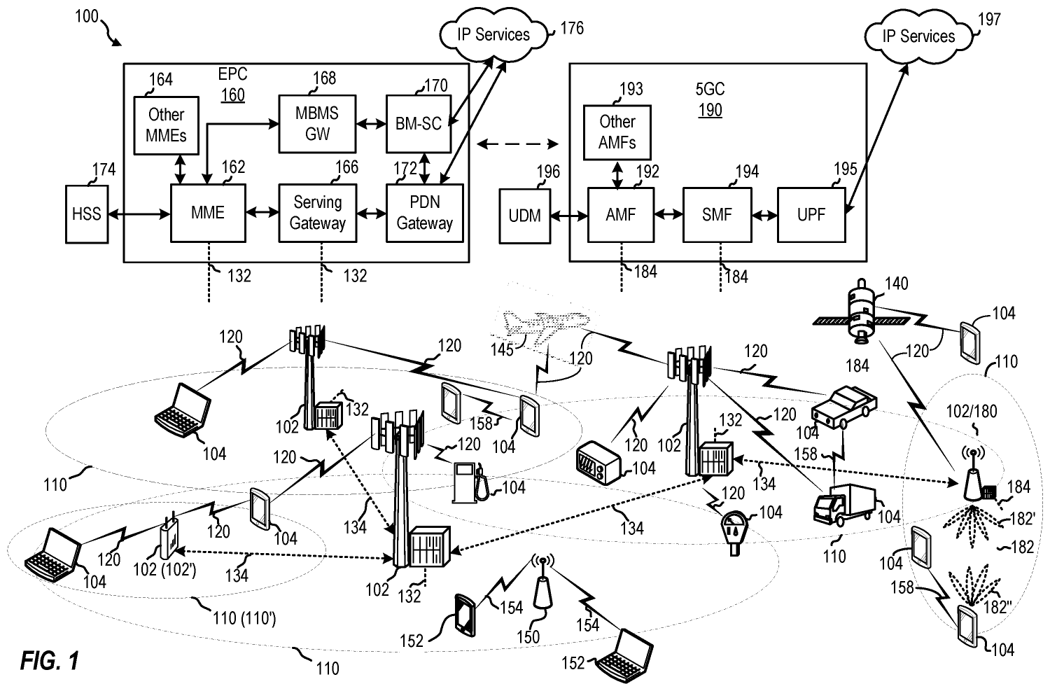

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

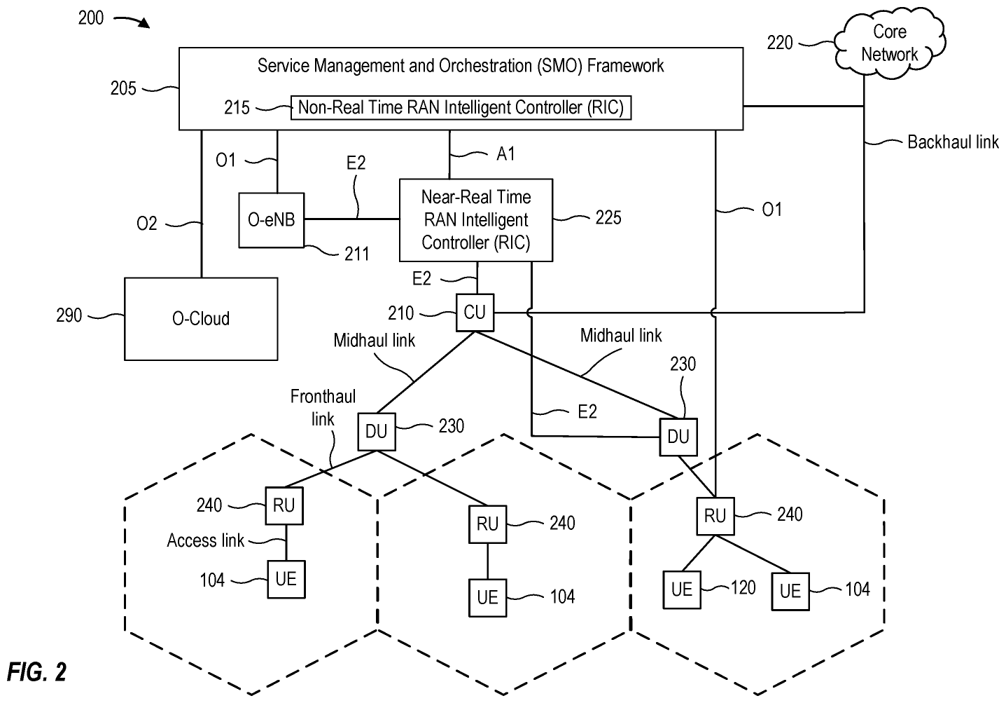

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mm Wave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the El interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

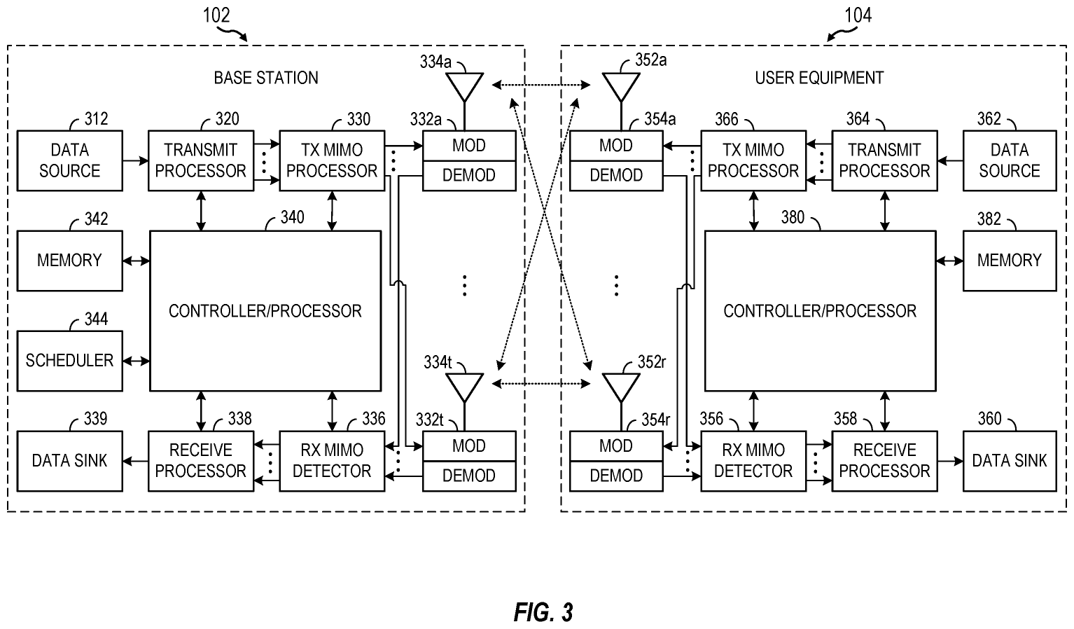

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

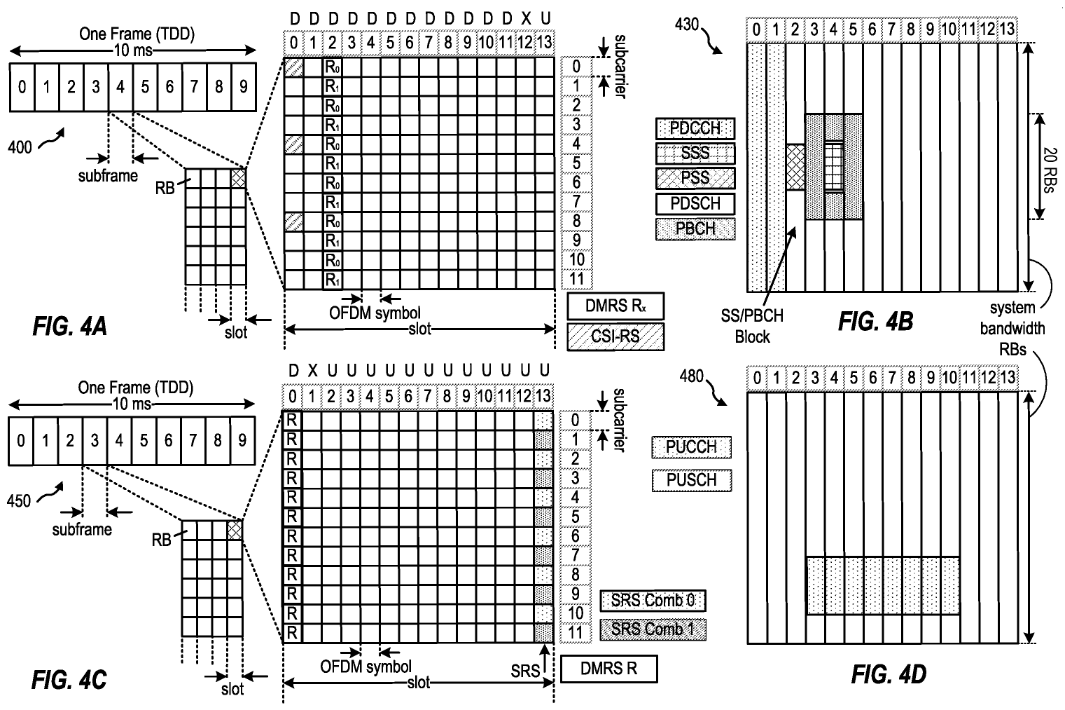

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIG. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to Energy Harvesting in RFID Systems

Radio frequency identification (RFID) is a rapidly growing technology impacting many industries due to its economic potential for inventory/asset management within warehouses, internet of things (IoT), sustainable sensor networks in factories and/or agriculture, and smart homes, to name a few example applications. RFID technology consists of RFID devices (or backscatter devices), such as transponders, or tags, that emit an information-bearing signal upon receiving an energizing signal.

In certain aspects, RFID devices may be operated without a battery. Generally, RFID devices that are operated without a battery are known as passive RFID devices. Passive RFID devices may operate by harvesting energy from received radio frequency signals (e.g., “over the air”), thereby powering reception and transmission circuitry within the RFID devices. This harvested energy allows passive RFID devices to transmit information, sometimes referred to as backscatter modulated information, without the need for a local power source within the RFID device. On the other hand, in certain aspects, an RFID device may be semi-passive and include on-board energy storage to supplement their ability to harvest energy from received signals (however, at higher cost).

In certain aspects, in addition to harvesting power from RF sources, energy harvesting devices may accumulate energy from other direct energy sources, such as solar energy, in order to supplement its power demands. Semi-passive energy harvesting devices may, in some cases, include power consuming RF components, such as analog to digital converters (ADCs), mixers, and oscillators.

Thus, RFID devices are a type of user equipment that provides low-cost and low-power solutions for many applications in a wireless communications system. Such devices may be very power efficient, sometimes requiring less than 0.1 mW of power to operate. Further, their relatively simple architectures and, in some cases, lack of battery, mean that such devices can be small, lightweight, and easily installed or integrated in many types of environments or host devices. Generally speaking then, RFID devices provide practical and necessary solutions to many networking applications that require, low-cost, small footprint, durable, maintenance-free, and long lifespan communications devices. For example, RFID devices may be configured as long endurance industrial sensors, which mitigates the problems of replacing batteries in and around dangerous machinery.

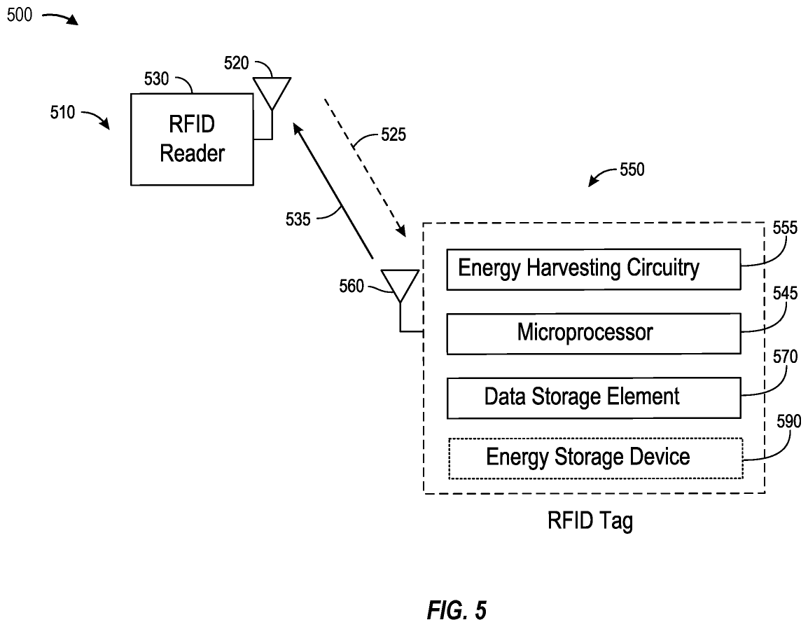

FIG. 5 shows an RFID system 500. As shown, RFID system 500 includes a reader 510 and an RFID tag 550. Reader 510 may also be referred to as an interrogator or a scanner. RFID tag 550 may also be referred to as an interrogator, RFID label, or an electronics label. In certain aspects, reader 510 is a network entity (e.g., such as a gNB) and RFID tag 550 is a user equipment (UE).

Reader 510 includes an antenna 520 and an electronics unit 530. Antenna 520 radiates signals transmitted by reader 510 and receives signals from RFID tags and/or other devices. Electronics unit 530 may include a transmitter and a receiver for reading RFID tags such as RFID tag 550. The same pair of transmitter and receiver (or another pair of transmitter and receiver) may support bi-directional communication with wireless networks, wireless devices, etc. Electronics unit 530 may include processing circuitry (e.g., a processor) to perform processing for data being transmitted and received by the RFID reader 510.

As shown, RFID tag 550 includes an antenna 560 and a data storage element 570. Antenna 560 radiates signals transmitted by RFID tag 550 and receives signals from RFID reader 510 and/or other devices. Data storage element 570 stores information for RFID tag 550, for example, in an electrically erasable programmable read-only memory (EEPROM) or another type of memory. RFID tag 550 may also include an electronics unit that can process the received signal and generate the signals to be transmitted.

In certain aspects, RFID tag 550 may be a passive RFID tag having no battery. In this case, induction may be used to power the RFID tag 550. For example, in some cases, a magnetic field from a signal transmitted by reader 510 may induce an electrical current in RFID tag 550, which may then operate based on the induced current. RFID tag 550 can radiate its signal in response to receiving a signal from RFID reader 510 or some other device. In certain other aspects, RFID tag 550 may optionally include an energy storage device 590, such as a battery, capacitor, etc., for storing energy harvested using energy harvesting circuitry 555, as described below.

In one example, RFID tag 550 may be read by placing the reader 510 within close proximity to RFID tag 550. Reader 510 may radiate a first signal 525 via the antenna 520. In some cases, the first signal 525 may be known as an interrogation signal or energy signal. In some cases, energy of the first signal 525 may be coupled from reader antenna 520 to RFID tag antenna 560 via magnetic coupling and/or other phenomena. In other words, the RFID tag 550 may receive the first signal 525 from reader 510 via antenna 560 and energy of the first signal 525 may be harvested using energy harvesting circuitry 555 (e.g., an RF transducer) and used to power RFID tag 550. For example, energy of the first signal 525 received by RFID tag 550 may be used to power a microprocessor 545 of RFID tag 550. Microprocessor 545 may, in turn, retrieve information stored in a data storage element 570 of RFID tag 550 and transmit the retrieved information via a second signal 535 using the antenna 560. For example, in some cases, microprocessor 545 may generate the second signal 535 by modulating a baseband signal (e.g., generated using energy of the first signal 525) with the information retrieved from the data storage element 570. In some cases, this second signal 535 may be known as a backscatter modulated information signal. Thereafter, as noted, microprocessor 545 transmits the second signal 535 to reader 510. Reader 510 may receive the second signal 535 from RFID tag 550 via antenna 520 and may process (e.g., demodulate) the received signal to obtain the information of data storage element 570 sent in second signal 535.

In some cases, RFID system 500 may be designed to operate at 13.56 MHz or some other frequency (e.g., an ultra-high frequency (UHF) band at 900 MHz). Reader 510 may have a specified maximum transmit power level, which may be imposed by the Federal Communication Commission (FCC) in the United Stated or other regulatory bodies in other countries. The specified maximum transmit power level of reader 510 may limit the distance at which RFID tag 550 can be read by reader 510.

Wireless technology is increasingly useful in industrial applications, such as ultra-reliable low-latency communication (URLLC) and machine type communication (MTC). In such domains, and others, it is desirable to support devices (e.g., passive RFID tags) that are capable of harvesting energy from wireless energy sources (e.g., in lieu of or in combination with a battery or other energy storage device, such as a capacitor), such as RF signals, thermal energy, solar energy, and the like.

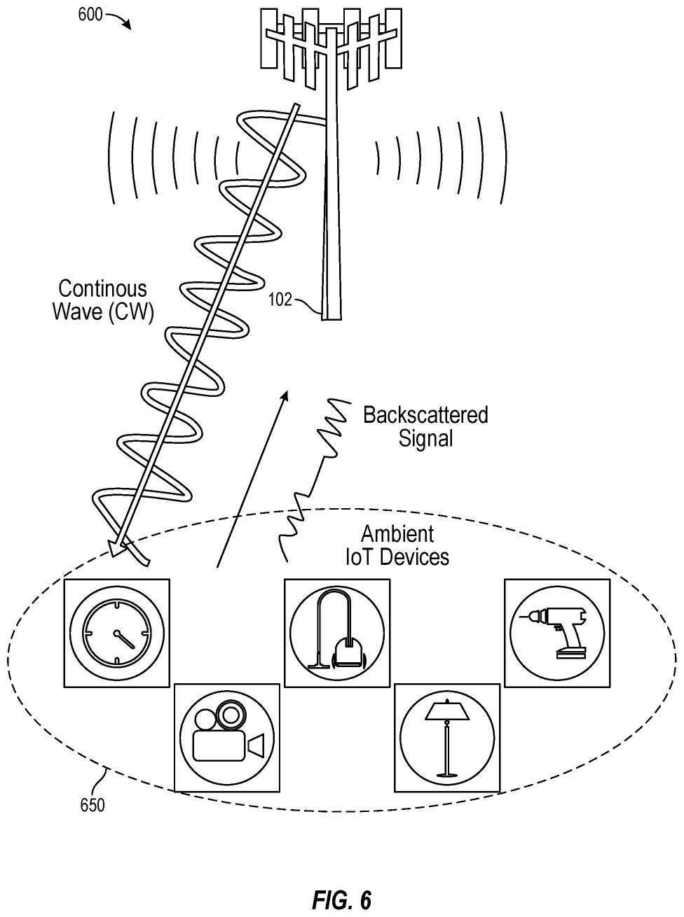

FIG. 6 depicts an example system 600 that utilizes a network entity (e.g., a gNB 102) to communicate with ambient IoT devices 650. The ambient IoT devices 650 may be used to monitor a variety of devices and processes. For example, IoT devices may be used to report sensor measurements, video signals/images, light readings, and control devices (e.g., as actuators).

Typical networks may not be able to efficiently support the most pervasive RFID-type of sensors, implemented as passive IoT devices. Such devices may be used extensively in future use cases, such as asset management, logistics, warehousing and manufacturing. Certain systems (e.g., 3GPP release 18 and above, 6G+) may be required to manage ambient IoT devices.

As illustrated in FIG. 6, a gNB may be able to read information stored on ambient IoT devices and/or write information to ambient IoT devices. The gNB can provide energy to the ambient IoT devices (e.g., via a continuous wave signal) and an information-bearing signal may be reflected back (“backscattered) to the gNB. The gNB may read the reflected signal from the ambient IoT to decode the information transmitted by the IoT devices 650.

### Aspects Related to Beamformed Bistatic Backscattering

In some implementations, RFID-type communications (e.g., ambient IoT) may be used in low bands. To implement RFID-type communication in low bands, RF energy harvesting, backscattering (e.g., for UL), simple reception (e.g., using on-off keying (OOK) modulation and envelope tracking for downlink (DL)) may be used. Backscattering and energy harvesting may also be implemented in higher bands. At higher bands, some of the challenges associated with higher bands include higher isotropic path loss. Therefore, beamforming (BF) and larger BF gains at both the reader and the tag device may be used to achieve a reasonable range. However, traditional BF architectures and procedures (e.g., introduced for normal operation) may not be suitable for some use cases because phased arrays are too complex, costly, and power-hungry for a tag device, and legacy beam management procedures are too complex and energy-demanding to be implemented by a tag device.

Certain aspects of the present disclosure are directed towards architectures that can support passive and simple beamformed retro-reflection. Some architectures allow passive beamforming for retro-reflection which is relevant for monostatic backscattering. With respect to bistatic backscattering, a passive/semi-passive tag device may rely on RF energy harvesting. For RF energy harvesting, the tag device may have high sensitivity (e.g., about −20 to −30 dBm for lower bands and about −10 dB for higher bands), limiting the EH range (e.g., only a few meters in higher bands). However for backscattering, what is important is the reader's sensitivity, which is much lower (e.g., about −90 to about −100 dBm), resulting in the typical backscatter range to be more than the energy harvesting range. Using a monostatic reader for energy harvesting and backscattering would provide a limited range dominated by the energy harvesting range, which is why bistatic readers are of high interest where a first device (device 1) sends the energy signal to the tag device and the tag device backscatters the signal to a second device (device 2).

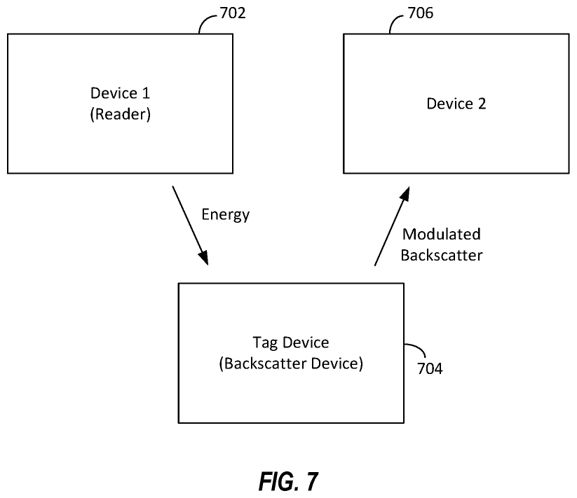

FIG. 7 illustrates a bistatic backscattering system, in accordance with certain aspects of the present disclosure. As shown, a first device 702 (e.g., labeled “Device 1”), which may be a reader device (e.g., corresponding to unit 530 of FIG. 5) may send an energy signal to a tag device 704 (e.g., corresponding to the tag device 550 of FIG. 5). The energy signal may be modulated and backscattered towards a second device 706 (e.g., labeled “Device 2”). Certain aspects are directed towards a device that supports low-power/low-cost beamformed bistatic backscattering, as described in more detail herein.

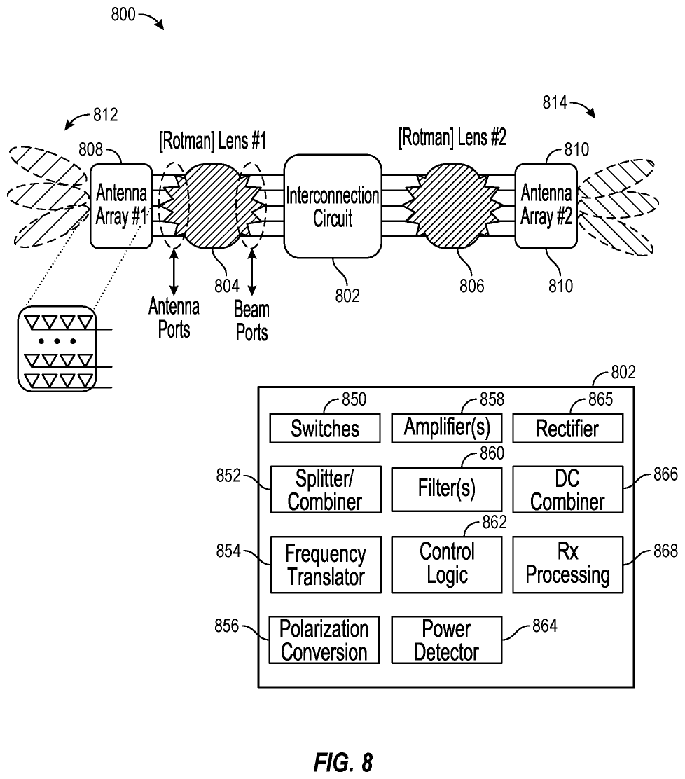

FIG. 8 illustrates a bistatic backscattering architecture 800 using Rotman lenses, in accordance with certain aspects of the present disclosure. As shown, architecture 800 includes an interconnection circuit 802 configured to selectively couple one or more of beam ports of the Rotman lens 804 to one or more of beam ports of the Rotman lens 806. A Rotman is a type of lens that includes a series waveguide structures that control signal amplitude and phase. A Rotman lens may be used to transmit and receive beamformed signals. For instance, a signal provided to one of the beam ports of the Rotman lens may result in a signal transmission in a particular direction associated with the beam port. Similarly, for reception, a signal received via a certain beam (e.g., direction) may have the highest power at one of the beam ports of the Rotman lens.

The two lenses 804, 806 may have the same or different architectures (e.g., in terms of number of beam ports, antenna ports, angular coverage region, array gain, operating frequency and/or bandwidth). The two lenses may operate at different frequencies in some aspects. In this case, the interconnection circuit 802 may be configured to support frequency translation of the signal while forwarding the signal from one side to the other side (e.g., from beam port side of lens 806 to beam port side of lens 804, or vice versa).

The two lenses may have different fields of view. For example, one lens (e.g., lens 804) may be coupled to antenna array 808 facing a first device (e.g., device 702 of FIG. 7, which may be a source of signal/energy) and another lens (e.g., lens 806) may be coupled to antenna array 810 facing a second device (e.g., device 706, which may be a receiver of the backscattered signal). As shown, the antenna array 808 may transmit signals using one or more transmit beams 812 and the antenna array 810 may receive signals using one or more receive beams 814. In some cases, the two lenses may also have (at least partially) the same field of view. In such a case, the architecture may allow monostatic backscattering (e.g., possibly using different RX and TX beams). In some aspects, multiple (e.g., more than 2) antenna arrays and Rotman lenses (e.g., each covering different angular regions) may be interconnected using an interconnection circuit, as described in more detail herein.

In some aspects, the interconnection circuit 802 may include one or more of components for signal processing. For example, the circuit 802 may include a set of switches 850 that would connect the beam ports of one lens to the beam ports of the other. The switches may allow one-to-one, one-to-many, many-to-one, and many-to-many interconnections. For more advanced connections, the circuit 802 may include power/signal splitters and/or combiners 852 (e.g., to split a signal into multiple signals to provided to multiple beam ports for transmission, or combine signals from multiple beam ports for reception). In some cases, the switches 850 may support flexible configurations (e.g., supporting any arrangement of interconnections) or a number of limited configurations.

In some aspects, the interconnection circuit 802 may include a modulator circuit (e.g., to modulate the backscatter signal using any suitable constellation, such as OOK, amplitude shift keying (ASK), phase shift keying (PSK), or frequency shift keying (FSK)).

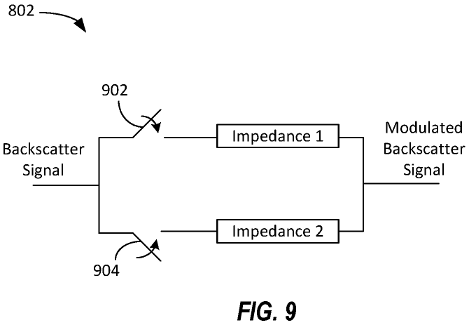

FIG. 9 illustrates example techniques for modulating the backscatter signal, in accordance with certain aspects of the present disclosure. The modulation may be via a set of different loads (with different impedances, labeled “Impedance 1” and “Impedance 2”) and switches (e.g., switches 902, 904) that can support switching across transmission lines connected to the different loads. For example, as shown, the interconnection circuit 802 may include switches 902, 904, which may selectively provide the backscatter signal to either impedance 1 or impedance 2 to generate a modulated backscatter signal.

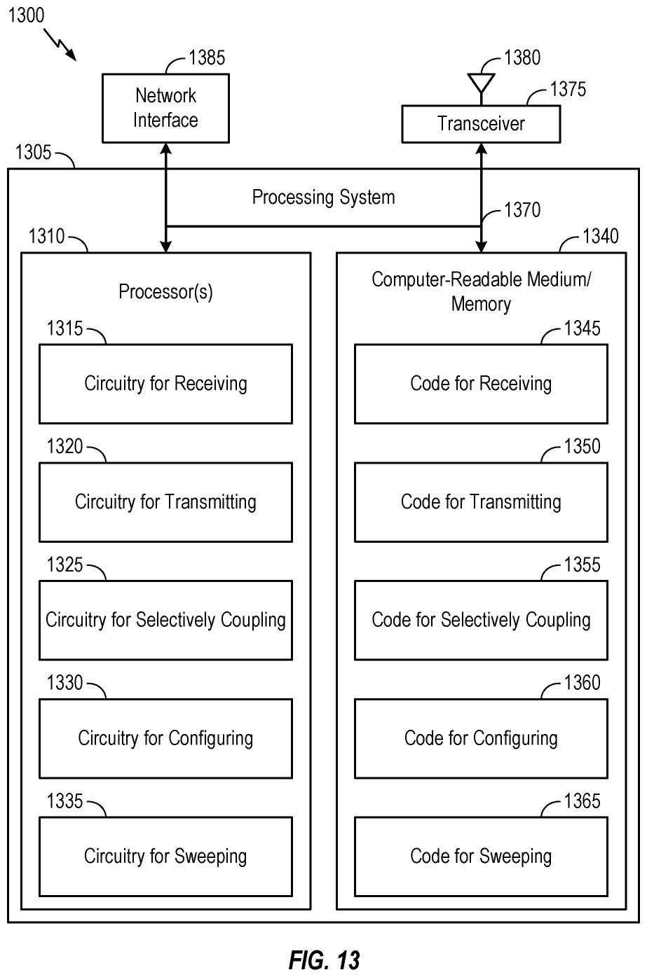

In some aspects, the circuit 802 may include a frequency translation circuit 854 (e.g., frequency doubler) for adjusting a frequency of a backscatter signal for signal transmission. The circuit 802 may include a polarization conversion/switching circuit 856 for adjusting a polarization of a backscatter signal for signal transmission. In some aspects, the circuit 802 may include a power amplification circuit 858 (e.g., provided by a simple power amplifier, or a load with negative reflection coefficient like a tunnel diode) for amplifying a signal for signal transmission. The circuit 802 may include one or more filters 860 providing filtering capabilities (e.g., using components that would reject, or reflect with small reflection coefficient, a range of frequencies such as tunnel diodes). The circuit 802 may also include a power detector 864 (e.g., for detecting the power at each beam port to identify the highest power receive beam), rectifiers 865 and DC combiners 866 to allow EH (e.g., for rectifying backscatter signals and combining the resultant DC signals for power), RX processing blocks 868 (e.g., for RX measurement or envelope tracking), and/or other control logic 862 (e.g., to adjust configurations in an autonomous or assisted manner, for example, by controlling switches of the circuit 802). In some aspects, the control logic 862 may include one or more processors (e.g., such as the processing system 1305 including processor(s) 1310 of FIG. 13), and may be part of the interconnection circuit 802 or separate from the interconnection circuit 802.

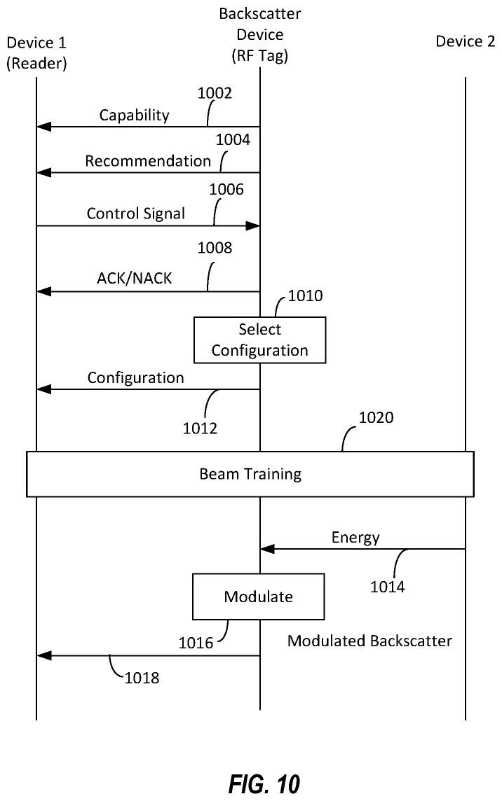

FIG. 10 illustrates an example of signaling to or from a backscattering device (e.g., RF tag), in accordance with certain aspects of the present disclosure. As shown, the backscatter device may share information 1002 with device 1 (e.g., a RFID reader or a network device), such as the capabilities, limitations, and supported configurations of the backscattering device. For instance, the backscattering device may indicate which beams and how many beam pairs the backscatter device can create, the effective combined gains of the beams, supported frequencies (e.g., assuming the device includes frequency translation or frequency doubling circuitry), or latency associated with beam switching (e.g., latency when switching from one transmit/receive beam to another). In some aspects, the backscatter device may receive a control signal 1006, indicating to select a specific configuration on a given set of time and/or frequency resources. The control signal 1006 may be received from device 1 (e.g., reader or network device).

In some aspects, the backscatter device may provide feedback 1008 (acknowledgment (ACK)/negative acknowledgment (NACK)) in response to receiving the control signal commanding selection (e.g., or change) of a configuration. In some aspects, the backscattering device selects a configuration (e.g., block 1010), and subsequently notifies (e.g., sends configuration 1012) device 1 regarding the selected configuration on a given set of resources. In some aspects, the backscatter device may transmit a recommendation 1004 of a configuration to be selected. In other words, the backscatter device may recommend a configuration, which may be taken into account when sending the control signal 1006. As shown, once the configuration is selected for bistatic backscattering, device 2 may send energy 1014 (e.g., backscatter signal) to the backscatter device, which may modulate the backscatter signal at block 1016 and send a modulated backscatter signal 1018 to device 1, as shown.

In some aspects, the backscattering device may support one or more bistatic beam-training procedures. For instance, beam training may be performed at block 1020 to select a beam for backscatter-type communications. In some aspects, to perform beam training, blind sweeping across all possible beam pairs may be performed. For example, one of the remote devices (e.g., device 1) may perform end-to-end measurements and coordination with the other device (e.g., device 2) and/or the tag device to share results of measurements and/or selected beam configuration. For example, the backscatter device may sweep transmit beams to communicate with device 1 while device 1 performs measurements to identify which beam provides the highest signal quality. The beam training may be coordinated with device 2 so that device 2 may supply the energy to the backscatter device to facilitate the backscatter device to sweep the transmit beams. Device 1 may also sweep receive beams while performing the measurements. Thus, device 1 may determine the highest quality transmit beam (e.g., of tag device) and receive beam (e.g., of device 2). This information may be communicated with device 2 and/or backscatter device to be used for backscatter-type communications.

In some aspects, one-side beam (e.g., receive beam) may be fixed (e.g., learned via retro-reflection or downlink (DL) measurements) and beam sweeping may be performed for the other side (e.g., transmit beam). For instance, device 1 may use a fixed receive beam. The backscatter device may sweep transmit beams while device 1 performs measurements to select a beam to be used for communication.

In some aspects, the one-side beams may be individually learned and a bistatic reflection may be created using the combination of the one-side beams. In other words, the backscatter device may individually learn a transmit beam to be used and device 1 may individually learn a receive beam to be used.

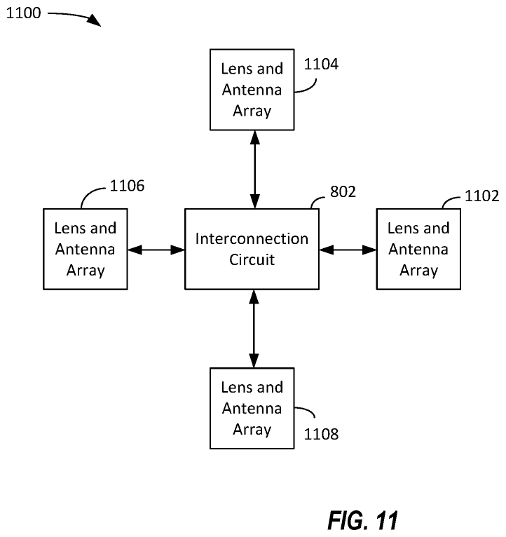

FIG. 11 illustrates bistatic-backscattering architecture 800 with four antenna arrays, in accordance with certain aspects of the present disclosure. While four antenna arrays (e.g., and four respective lenses) are shown, any number of antenna arrays may be used. The interconnection circuit 802 may include circuitry (e.g., switches, modulators, etc.) to control each lens (Rotman lens) and antenna arrays 1102, 1104, 1106, 1108 in a similar manner as described with respect to FIG. 8. In some aspects, multi-input to single-output, single-input to multi-output, and multi-input to multi-output (MIMO) configurations may be used (e.g., for beam management, or normal data/control communication). For example, for multi-input to single-output, arrays 1102, 1104, 1106 may be used for signal reception (e.g., reception of backscatter signal) while array 1108 is used for signal transmission (e.g., transmission of a modulated backscatter signal). For single-input to multi-output, array 1102 may be used for signal reception and arrays 1104, 1106, 1108 may be used for signal transmission. For MIMO configurations, arrays 1102, 1104 may be used for signal reception and arrays 1106, 1108 may be used for signal transmission. In some aspects, the backscatter device may support backscattering different information on different paths (e.g., when supporting multiple output transmissions). For example, the circuit 802 may include modulators that modulate different data for transmission on different antenna arrays.

### Example Operations

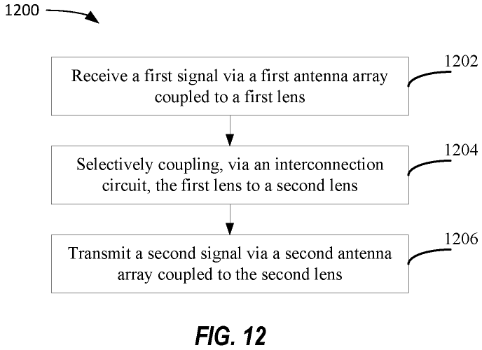

FIG. 12 shows an example of a method 1200 of wireless communications at a wireless device, such as a tag device (e.g., device 704 of FIG. 7), a reader device (e.g., reader device 702 of FIG. 7), which may be implemented using the architecture 800 or architecture 1100.

At block 1202, the wireless device receives a first signal via a first antenna array coupled to a first lens (e.g., a first Rotman lens). In some cases, the operations of this step refer to, or may be performed by, circuitry for receiving and/or code for receiving as described with reference to FIG. 13.

At block 1204, the wireless device selectively couples, via an interconnection circuit, the first lens to a second lens (e.g., a second Rotman lens). In some cases, the operations of this step refer to, or may be performed by, circuitry for selectively coupling and/or code for selectively coupling as described with reference to FIG. 13. For example, the first lens may be selectively coupled to the second lens via one or more switches of the interconnection circuit. In some aspects, the first lens may include a first plurality of antenna ports coupled to the first antenna array and a first plurality of beam ports coupled to the interconnection circuit. The second lens may include a second plurality of antenna ports coupled to the second antenna array and a second plurality of beam ports coupled to the interconnection circuit. The interconnection circuit may include switches. Selectively coupling the first lens to the second lens may include selectively coupling, via the switches, each of the first plurality of beam ports to one or more of the second plurality of beam ports.

At block 1206, the wireless devices transmits a second signal via a second antenna array coupled to the second lens. In some cases, the operations of this step refer to, or may be performed by, circuitry for transmitting and/or code for transmitting as described with reference to FIG. 13. For example, the wireless device may modulate, via a modulator of the interconnection circuit, the first signal to generate a modulated signal, wherein the second signal comprises the modulated signal.

In some aspects, the wireless device may transmit information indicating a capability (e.g., information 1002 of FIG. 10) of the apparatus associated with backscattering type communication. The information may indicate at least one of one or more beams supported for the backscatter type communication, a quantity of beams supported for the backscatter type communication, supported gain associated with the backscatter type communication, one or more frequencies supported for the backscatter type communication, or a beam switching latency.

In some aspects, the wireless device receives a control signal (e.g., control signal 1006) indicating a configuration for transmission of the second signal and configures the interconnection circuit based on the control signal. The second signal may be transmitted using the configuration. In some aspects, the wireless device may transmit an acknowledgement or negative acknowledgement signal (e.g., feedback 1008) in response to receiving the control signal. The wireless device may transmit a configuration recommendation (e.g., recommendation 1004), in some aspects. The control signal indicating the configuration may be based on the configuration recommendation. In some aspects, the control signal indicates the configuration for at least one of time or frequency resources. In some aspects, the wireless device may select a configuration for backscattering communication and transmit an indication of the configuration (e.g., configuration 1012) via the first antenna array.

In some aspects, the wireless device sweeps a plurality of transmit beams and receives an indication of one of the plurality of transmit beams to be used for transmitting the second signal. In some cases, a receive beam may be fixed while the plurality of transmit beams of swept.

In some aspects, the interconnection circuit may include at least one of one or more modulator circuits, one or more signal splitter and combiner circuits, one or more frequency translators, one or more polarization conversion circuits, one or more amplifiers, one or more filters, one or more rectifiers, one or more DC signal combiners, one or more power detectors, control logic, or one or more receive processors.

### Example Communications Device(s)

FIG. 13 depicts aspects of an example communications device 1300. In some aspects, communications device 1300 is a user equipment, such as UE 104 described above with respect to FIGS. 1 and 3. In some aspects, communications device 1300 is a network entity, such as BS 102 of FIGS. 1 and 3, or a disaggregated base station as discussed with respect to FIG. 2.

The communications device 1300 includes a processing system 1305 coupled to the transceiver 1375 (e.g., a transmitter and/or a receiver). In some aspects (e.g., when communications device 1300 is a network entity), processing system 1305 may be coupled to a network interface 1385 that is configured to obtain and send signals for the communications device 1300 via communication link(s), such as a backhaul link, midhaul link, and/or fronthaul link as described herein, such as with respect to FIG. 2. The transceiver 1375 is configured to transmit and receive signals for the communications device 1300 via the antenna 1380, such as the various signals as described herein. The processing system 1305 may be configured to perform processing functions for the communications device 1300, including processing signals received and/or to be transmitted by the communications device 1300.

The processing system 1305 includes one or more processors 1310. In various aspects, the one or more processors 1310 may be representative of one or more of receive processor 358, transmit processor 364, TX MIMO processor 366, and/or controller/processor 380, as described with respect to FIG. 3. In various aspects, one or more processors 1310 may be representative of one or more of receive processor 338, transmit processor 320, TX MIMO processor 330, and/or controller/processor 340, as described with respect to FIG. 3. The one or more processors 1310 are coupled to a computer-readable medium/memory 1340 via a bus 1370. In certain aspects, the computer-readable medium/memory 1340 is configured to store instructions (e.g., computer-executable code) that when executed by the one or more processors 1310, cause the one or more processors 1310 to perform the method 1200 described with respect to FIG. 12, or any aspect related to it. Note that reference to a processor performing a function of communications device 1300 may include one or more processors 1310 performing that function of communications device 1300.

In the depicted example, computer-readable medium/memory 1340 stores code (e.g., executable instructions), such as code for receiving 1345, code for transmitting 1350, code for selectively coupling 1355, code for configuring 1360, and code for sweeping 1365. Processing of the code for receiving 1345, code for transmitting 1350, code for selectively coupling 1355, code for configuring 1360, and code for sweeping 1365 may cause the communications device 1300 to perform the method 1200 described with respect to FIG. 12.

The one or more processors 1310 include circuitry configured to implement (e.g., execute) the code stored in the computer-readable medium/memory 1340, including circuitry for receiving 1315, circuitry for transmitting 1320, circuitry for selectively coupling 1325, circuitry for configuring 1330, and circuitry for sweeping 1335. Processing with circuitry for receiving 1315, circuitry for transmitting 1320, circuitry for selectively coupling 1325, circuitry for configuring 1330, and circuitry for sweeping 1335 may cause the communications device 1300 to perform the method 1200 described with respect to FIG. 12, or any aspect related to it.

Various components of the communications device 1300 may provide means for performing the method 1200 described with respect to FIG. 12. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1375 and the antenna 1380 of the communications device 1300 in FIG. 13. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1375 and the antenna 1380 of the communications device 1300 in FIG. 13.

### Example Clauses

Aspect 1: An apparatus for wireless communications, comprising: a first antenna array; a first lens; an interconnection circuit coupled between the first antenna array and the first lens; a second lens; and a second antenna array, the second lens being coupled between the interconnection circuit and the second antenna array.

Aspect 2: The apparatus of Aspect 1, wherein each of the first lens and the second lens comprises a Rotman lens.

Aspect 3: The apparatus of Aspect 1 or 2, wherein the interconnection circuit comprises one or more switches.

Aspect 4: The apparatus according to any of Aspects 1-3, wherein: the first lens comprises a first plurality of antenna ports coupled to the first antenna array and a first plurality of beam ports coupled to the interconnection circuit; and the second lens comprises a second plurality of antenna ports coupled to the second antenna array and a second plurality of beam ports coupled to the interconnection circuit.

Aspect 5: The apparatus of Aspect 4, wherein the interconnection circuit includes switches configured to selectively couple each of the first plurality of beam ports to one or more of the second plurality of beam ports.

Aspect 6: The apparatus according to any of Aspects 1-5, wherein the interconnection circuit comprises at least one of one or more modulator circuits, one or more signal splitter and combiner circuits, one or more frequency translators, one or more polarization conversion circuits, one or more amplifiers, one or more filters, one or more rectifiers, one or more direct current (DC) signal combiners, one or more power detectors, control logic, or one or more receive processors.

Aspect 7: The apparatus according to any of Aspects 1-6, wherein the interconnection circuit comprises control logic configured to transmit, via the first antenna array, information indicating a capability of the apparatus associated with backscatter type communication.

Aspect 8: The apparatus of Aspect 7, wherein the information indicates at least one of: one or more beams supported for the backscatter type communication, a quantity of beams supported for the backscatter type communication, supported gain associated with the backscatter type communication, one or more frequencies supported for the backscatter type communication, or a beam switching latency.

Aspect 9: The apparatus according to any of Aspects 1-8, wherein the interconnection circuit is configured to receive, via the second antenna array, a control signal indicating a configuration for backscatter type communication, wherein the interconnection circuit is configured based on the control signal.

Aspect 10: The apparatus of Aspect 9, wherein the interconnection circuit is configured to transmit, via the first antenna array, an acknowledgement or negative acknowledgement signal in response to receiving the control signal.

Aspect 11: The apparatus of Aspect 9 or 10, wherein the interconnection circuit is configured to transmit, via the first antenna array, a configuration recommendation for the backscatter type communication, the control signal indicating the configuration based on the configuration recommendation.

Aspect 12: The apparatus according to any of Aspects 9-11, wherein the control signal indicates the configuration for the backscatter type communication for at least one of time or frequency resources.

Aspect 13: The apparatus according to any of Aspects 1-12, wherein the interconnection circuit is configured to: select a configuration for backscattering communication; and transmit an indication of the configuration via the first antenna array.

Aspect 14: The apparatus according to any of Aspects 1-13, wherein the interconnection circuit is configured to: sweep a plurality of transmit beams; and receive, via the second antenna array, an indication of one of the plurality of transmit beams to be used for backscattering communication.

Aspect 15: The apparatus of Aspect 14, wherein a receive beam is fixed while the plurality of transmit beams of swept.

Aspect 16: The apparatus according to any of Aspects 1-15, wherein the first antenna array has a different field of view than the second antenna array.

Aspect 17: The apparatus according to any of Aspects 1-16, wherein the first antenna array has the same field of view as the second antenna array.

Aspect 18: The apparatus according to any of Aspects 1-17, further comprising: a third lens; and a third antenna array, the third lens being coupled between the interconnection circuit and the third antenna array.

Aspect 19: The apparatus of Aspect 18, wherein the first antenna array and the second antenna array are configured for signal reception and the third antenna array is configured for signal transmission.

Aspect 20: The apparatus of Aspect 18 or 19, wherein the first antenna array and the second antenna array are configured for signal transmission and the third antenna array is configured for signal reception.

Aspect 21: A method for wireless communications at an apparatus, comprising: receiving a first signal via a first antenna array coupled to a first lens; selectively coupling, via an interconnection circuit, the first lens to a second lens; and transmitting a second signal via a second antenna array coupled to the second lens.

Aspect 22: The method of Aspect 21, wherein each of the first lens and the second lens comprises a Rotman lens.

Aspect 23: The method of Aspect 21 or 22, wherein the first lens is selectively coupled to the second lens via one or more switches of the interconnection circuit.

Aspect 24: The method according to any of Aspects 21-23, wherein: the first lens comprises a first plurality of antenna ports coupled to the first antenna array and a first plurality of beam ports coupled to the interconnection circuit; and the second lens comprises a second plurality of antenna ports coupled to the second antenna array and a second plurality of beam ports coupled to the interconnection circuit.

Aspect 25: The method of Aspect 24, wherein the interconnection circuit includes switches, wherein selectively coupling the first lens to the second lens comprises selectively coupling, via the switches, each of the first plurality of beam ports to one or more of the second plurality of beam ports.

Aspect 26: The method according to any of Aspects 21-25, further comprising modulating, via a modulator of the interconnection circuit, the first signal to generate a modulated signal, wherein the second signal comprises the modulated signal.

Aspect 27: The method according to any of Aspects 21-26, further comprising transmitting information indicating a capability of the apparatus associated with backscattering type communication.

Aspect 28: The method of Aspect 27, wherein the information indicates at least one of: one or more beams supported for the backscatter type communication, a quantity of beams supported for the backscatter type communication, supported gain associated with the backscatter type communication, one or more frequencies supported for the backscatter type communication, or a beam switching latency.

Aspect 29: The method according to any of Aspects 21-28, further comprising: receiving a control signal indicating a configuration for transmission of the second signal; and configuring the interconnection circuit based on the control signal, wherein the second signal is transmitted using the configuration.

Aspect 30: The method of Aspect 29, further comprising transmitting, via the first antenna array, an acknowledgement or negative acknowledgement signal in response to receiving the control signal.

Aspect 31: The method of Aspect 29 or 30, further comprising transmitting a configuration recommendation, the control signal indicating the configuration based on the configuration recommendation.

Aspect 32: The method according to any of Aspects 29-31, wherein the control signal indicates the configuration for at least one of time or frequency resources.

Aspect 33: The method according to any of Aspects 21-32, further comprising: selecting a configuration for backscattering communication; and transmitting an indication of the configuration via the first antenna array.

Aspect 34: The method according to any of Aspects 21-33, further comprising: sweeping a plurality of transmit beams; and receiving an indication of one of the plurality of transmit beams to be used for transmitting the second signal.

Aspect 35: The method of Aspect 34, wherein a receive beam is fixed while the plurality of transmit beams are swept.

Aspect 36: An apparatus for wireless communication, comprising: a memory; and one or more processors coupled to the memory, the one or more processors being configured to: receive a first signal via a first antenna array coupled to a first lens; control selective coupling of the first lens to a second lens via an interconnection circuit; and transmit a second signal via a second antenna array coupled to the second lens.

Aspect 37: The apparatus of Aspect 36, wherein each of the first lens and the second lens comprises a Rotman lens.

Aspect 38: The apparatus of Aspect 36 or 37, wherein the first lens is selectively coupled to the second lens via one or more switches of the interconnection circuit.

Aspect 39: The apparatus according to any of Aspects 36-38, wherein: the first lens comprises a first plurality of antenna ports coupled to the first antenna array and a first plurality of beam ports coupled to the interconnection circuit; and the second lens comprises a second plurality of antenna ports coupled to the second antenna array and a second plurality of beam ports coupled to the interconnection circuit.

Aspect 40: The apparatus of Aspect 39, wherein the interconnection circuit includes switches, wherein, to control selective coupling of the first lens to the second lens, the one or more processors are configured to control selective coupling, via the switches, each of the first plurality of beam ports to one or more of the second plurality of beam ports.

Aspect 41: The apparatus according to any of Aspects 36-40, wherein the one or more processors are configured to cause modulation of the first signal to generate a modulated signal via a modulator of the interconnection circuit, wherein the second signal comprises the modulated signal.

Aspect 42: The apparatus according to any of Aspects 36-41, wherein the one or more processors are configured to transmit information indicating a capability of the apparatus associated with backscattering type communication.

Aspect 43: The apparatus of Aspect 42, wherein the information indicates at least one of: one or more beams supported for the backscatter type communication, a quantity of beams supported for the backscatter type communication, supported gain associated with the backscatter type communication, one or more frequencies supported for the backscatter type communication, or a beam switching latency.

Aspect 44: The apparatus according to any of Aspects 36-43, wherein the one or more processors are further configured to: receive a control signal indicating a configuration for transmission of the second signal; and configure the interconnection circuit based on the control signal, wherein the one or more processors are configured to transmit the second signal using the configuration.

Aspect 45: The apparatus of Aspect 44, wherein the one or more processors are further configured to transmit, via the first antenna array, an acknowledgement or negative acknowledgement signal in response to receiving the control signal.

Aspect 46: The apparatus of Aspect 44 or 45, wherein the one or more processors are further configured to transmit a configuration recommendation, the control signal indicating the configuration based on the configuration recommendation.

Aspect 47: The apparatus according to any of Aspects 44-46, wherein the control signal indicates the configuration for at least one of time or frequency resources.

Aspect 48: The apparatus according to any of Aspects 36-47, wherein the one or more processors are configured to: select a configuration for backscattering communication; and transmit an indication of the configuration via the first antenna array.

Aspect 49: The apparatus according to any of Aspects 36-48, wherein the one or more processors are configured to: sweep a plurality of transmit beams; and receive an indication of one of the plurality of transmit beams to be used for transmitting the second signal.

Aspect 50: The apparatus of Aspect 49, wherein a receive beam is fixed while the plurality of transmit beams are swept.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communications, comprising:
a first antenna array;
a first lens;
an interconnection circuit coupled between the first antenna array and the first lens;
a second lens; and
a second antenna array, the second lens being coupled between the interconnection circuit and the second antenna array.

2. The apparatus of claim 1, wherein each of the first lens and the second lens comprises a Rotman lens.

3. The apparatus of claim 1, wherein:
the first lens comprises a first plurality of antenna ports coupled to the first antenna array and a first plurality of beam ports coupled to the interconnection circuit; and
the second lens comprises a second plurality of antenna ports coupled to the second antenna array and a second plurality of beam ports coupled to the interconnection circuit.

4. The apparatus of claim 3, wherein the interconnection circuit includes switches configured to selectively couple each of the first plurality of beam ports to one or more of the second plurality of beam ports.

5. The apparatus of claim 1, wherein the interconnection circuit comprises at least one of one or more modulator circuits, one or more signal splitter and combiner circuits, one or more frequency translators, one or more polarization conversion circuits, one or more amplifiers, one or more filters, one or more rectifiers, one or more direct current (DC) signal combiners, one or more power detectors, control logic, or one or more receive processors.

6. The apparatus of claim 1, wherein the interconnection circuit comprises control logic configured to transmit, via the first antenna array, information indicating a capability of the apparatus associated with backscatter type communication.

7. The apparatus of claim 6, wherein the information indicates at least one of: one or more beams supported for the backscatter type communication, a quantity of beams supported for the backscatter type communication, supported gain associated with the backscatter type communication, one or more frequencies supported for the backscatter type communication, or a beam switching latency.

8. The apparatus of claim 1, wherein the interconnection circuit is configured to receive, via the second antenna array, a control signal indicating a configuration for backscatter type communication, wherein the interconnection circuit is configured based on the control signal.

9. The apparatus of claim 8, wherein the interconnection circuit is configured to transmit, via the first antenna array, an acknowledgement or negative acknowledgement signal in response to receiving the control signal.

10. The apparatus of claim 8, wherein the interconnection circuit is configured to transmit, via the first antenna array, a configuration recommendation for the backscatter type communication, the control signal indicating the configuration based on the configuration recommendation.

11. The apparatus of claim 1, wherein the interconnection circuit is configured to:
select a configuration for backscattering communication; and
transmit an indication of the configuration via the first antenna array.

12. The apparatus of claim 1, wherein the interconnection circuit is configured to:
sweep a plurality of transmit beams; and
receive, via the second antenna array, an indication of one of the plurality of transmit beams to be used for backscattering communication.

13. The apparatus of claim 12, wherein a receive beam is fixed while the plurality of transmit beams of swept.

14. The apparatus of claim 1, wherein the first antenna array has a different field of view than the second antenna array.

15. The apparatus of claim 1, further comprising:
a third lens; and
a third antenna array, the third lens being coupled between the interconnection circuit and the third antenna array.

16. The apparatus of claim 15, wherein the first antenna array and the second antenna array are configured for signal reception and the third antenna array is configured for signal transmission.

17. An apparatus for wireless communication, comprising:
a memory; and
one or more processors coupled to the memory, the one or more processors being configured to:
receive a first signal via a first antenna array coupled to a first lens;
control selective coupling of the first lens to a second lens via an interconnection circuit,; and
transmit a second signal via a second antenna array coupled to the second lens.

18. The apparatus of claim 17, wherein each of the first lens and the second lens comprises a Rotman lens.

19. The apparatus of claim 17, wherein the first lens is selectively coupled to the second lens via one or more switches of the interconnection circuit.

20. The apparatus of claim 17, wherein:
the first lens comprises a first plurality of antenna ports coupled to the first antenna array and a first plurality of beam ports coupled to the interconnection circuit; and
the second lens comprises a second plurality of antenna ports coupled to the second antenna array and a second plurality of beam ports coupled to the interconnection circuit.

21. The apparatus of claim 20, wherein the interconnection circuit includes switches, wherein, to control selective coupling of the first lens to the second lens, the one or more processors are configured to control selective coupling, via the switches, each of the first plurality of beam ports to one or more of the second plurality of beam ports.

22. The apparatus of claim 17, wherein the one or more processors are configured to cause modulation of the first signal to generate a modulated signal via a modulator of the interconnection circuit, wherein the second signal comprises the modulated signal.

23. The apparatus of claim 17, wherein the one or more processors are configured to transmit information indicating a capability of the apparatus associated with backscattering type communication.

24. The apparatus of claim 23, wherein the information indicates at least one of: one or more beams supported for the backscatter type communication, a quantity of beams supported for the backscatter type communication, supported gain associated with the backscatter type communication, one or more frequencies supported for the backscatter type communication, or a beam switching latency.

25. The apparatus of claim 17, wherein the one or more processors are further configured to:
receive a control signal indicating a configuration for transmission of the second signal; and
configure the interconnection circuit based on the control signal, wherein the one or more processors are configured to transmit the second signal using the configuration.

26. The apparatus of claim 25, wherein the one or more processors are further configured to transmit, via the first antenna array, an acknowledgement or negative acknowledgement signal in response to receiving the control signal.

27. The apparatus of claim 25, wherein the one or more processors are further configured to transmit a configuration recommendation, the control signal indicating the configuration based on the configuration recommendation.

28. The apparatus of claim 17, wherein the one or more processors are configured to:
select a configuration for backscattering communication; and
transmit an indication of the configuration via the first antenna array.

29. The apparatus of claim 17, wherein the one or more processors are configured to:
sweep a plurality of transmit beams; and
receive an indication of one of the plurality of transmit beams to be used for transmitting the second signal.

30. A method for wireless communications at an apparatus, comprising:
receiving a first signal via a first antenna array coupled to a first lens;
selectively coupling, via an interconnection circuit, the first lens to a second lens; and
transmitting a second signal via a second antenna array coupled to the second lens.
